(19) United States
(12) Patent Application Publication
(10) Pub. No.: US 2003/0061609 A1
(43) Pub. Date: Mar. 27, 2003

(54) Television capable of displaying an electronic program guide and method for using the same

(76) Inventor: Hyo-Jin Son, Suwon-City (KR)

Correspondence Address: Joseph J. Buczynski, Roylance, Abrams, Berdo & Goodman, L.L.P., Suite 600, 1300 19th Street, Washington, DC, 20036, US

(21) Appl. No.: 10/232,688

(22) Filed: Sep. 3, 2002

(30) Foreign Application Priority Data
Sep. 27, 2001 (KR) 2001-60220

(51) Int. Cl. G06F 3/00; H04N 5/445; G06F 13/00

(52) U.S. Cl. 725/39; 725/55; 725/61

(57) ABSTRACT

A TV for displaying EPG information in an improved manner, and a method for using the same. The TV includes a storage unit adapted to store a received EPG information, a display unit adapted to display the EPG information, an input unit adapted to input a selection command regarding a predetermined channel among receivable channels, and a controller adapted to control the storage unit to store the EPG information among received broadcasting signals, and to control the display unit to display the stored EPG information. Specifically, the controller controls the display unit to display the EPG information with respect to the channel selected by the selection command and a list of channels that can be selected by the user on the display unit on a single screen. Moreover, channels that are not currently displayed on the screen and time information that is not currently displayed in selected channels can be displayed on the screen by using up/down scroll bars. Therefore, because a plurality of channels and the program information of the selected channels are displayed on one screen, a user can easily view the EPG information in an efficient manner.

This application claims benefit under 35 U.S.C. § 119 from Korean Patent Application No. 2001-60220, filed on Sep. 27, 2001, the entire content of which is incorporated herein by reference.

### BACKGROUND OF THE INVENTION

1. Field of the Invention:

The present invention relates to an apparatus and a method for receiving a television (TV) broadcasting signal including electronic program guide (EPG) information, and more particularly, to a TV capable of receiving an EPG signal including program information among TV broadcasting signals and displaying EPG information to enable a user to select from the EPG information a desired program for viewing.

2. Description of the Related Art:

In the past, not many conventional TV channels existed, so viewers did not have difficulty selecting a desired TV channel for viewing. However, as the viewers' demands for various kinds of programming have increased, the number of available channels has also increased. Conventionally, viewers would check the airing times of programs by using newspapers, magazines or other printed programming guides, and tune their television to the appropriate channel to view the programs of interest. However, this conventional method gives rise to some problems. For example, the viewers have to constantly refer back to the newspapers and magazines to locate desired programs. Also, the information describing the program is typically not sufficient in newspapers and magazines and hence, a viewer may have to start watching the program before he or she determines whether it is of interest. For these reasons, viewers may find themselves wasting time unnecessarily when trying to locate programs of interest to view.

To solve the above problems, a TV using EPG information has been developed.. As shown in FIGS. 1A and 1B, the EPG information is displayed on screen 40 of the conventional TV 100. When a user selects the EPG screen, an upper menu is displayed on the screen as shown in FIG. 1A so that the user can check the list of currently available channels. When a channel (for example, CH 03) is selected by a selection command of the user, the order of the programs being aired by the selected channel (CH 03) with respect to their air times are displayed on the screen in a lower menu as shown in FIG. 1B. When there is no program desired by the user, the user can issue a command to close the lower menu and can search other channels. In other words, the user has to select another channel after returning to the screen of the upper menu as shown in FIG. 1A.

It is expected that when digital broadcasting becomes more prevalent, the number of available channels will increase substantially. Therefore, it will become burdensome for the user to constantly switch between the screen that displays the available channels as shown in FIG. 1A and the screen that displays the programming schedule for a selected channel as shown in FIG. 1B. Accordingly, a need exists for a TV that is capable of providing an EPG display that a user can use more efficiently.

### SUMMARY OF THE INVENTION

The present invention has been developed to overcome the above-mentioned problem of the conventional techniques. Accordingly, it is the object of the present invention to provide a TV that is capable of displaying an EPG that a user can easily use in a convenient and simple manner to search available channels as well as programs aired by those channels.

The above object of the present invention is substantially realized by providing a TV comprising a storage unit adapted to store received EPG information, a display unit adapted to display the EPG information, an input unit adapted to input a selection command identifying a predetermined channel among receivable channels, and a controller adapted to control the storage unit to store the EPG information among received broadcasting signals and to control the display unit to display the stored EPG information.

Preferably, the controller controls the display unit to display the EPG information with respect to the channel selected by the selection command and a list of channels that can be selected by the user on the display unit in one screen.

It is also preferable that the list displayed on the screen include at least some of the channels that can be selected, and a display command that can be selected by the user to input a command to the input unit which causes the controller to control the display unit to display the channels that are not currently displayed on the screen. Moreover, the program airing time information relating to the programs being displayed is displayed on one part of the screen, and another display command is also displayed which can be selected by the user to input a command to the input unit which causes the controller to control the display unit to display program and airing time information for additional programs not currently displayed on the screen which are being aired by the selected channel.

### BRIEF DESCRIPTION OF THE DRAWINGS

The above-mentioned objects and the features of the present invention will be more apparent by describing the preferred embodiment of the present invention by referring to the appended drawings, in which:

FIGS. 1A and 1B illustrate conventional EPG information displayed on a screen of a TV;

FIG. 2 is a block diagram showing an example of components of a TV capable of receiving and displaying EPG information according to the present invention; and

FIG. 3 illustrates an example of EPG information displayed on the screen of a TV having the components according to FIG. 2.

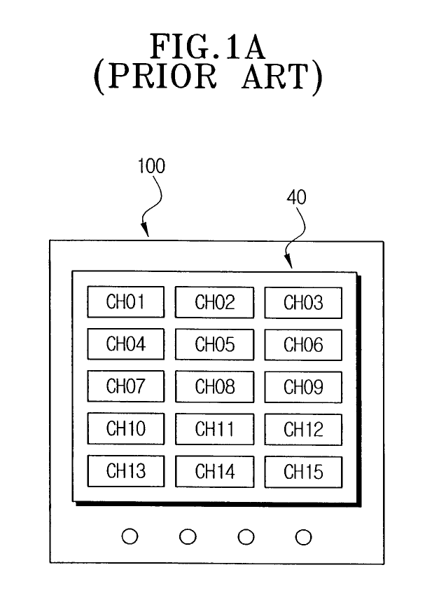

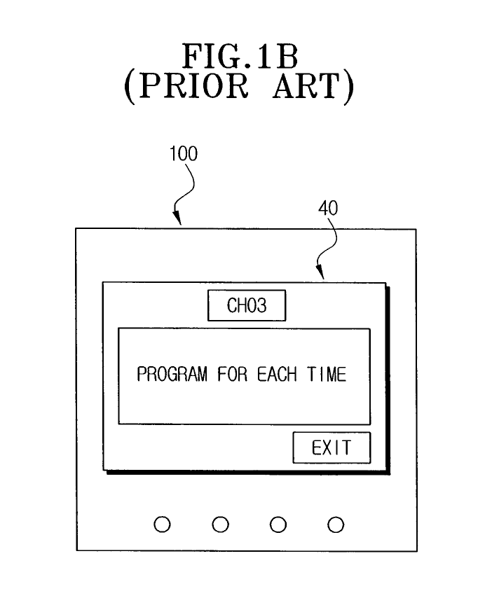

### DETAILED DESCRIPTION OF THE PREFERRED EMBODIMENTS

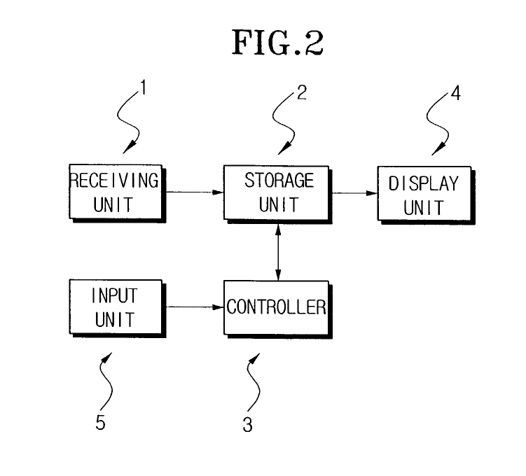

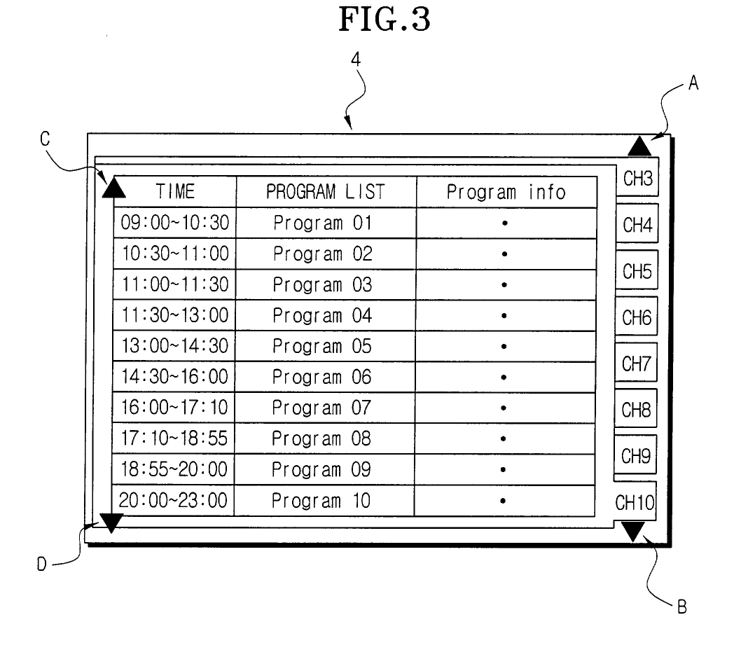

A TV for displaying EPG information according to an embodiment of the present invention will be described in greater detail with reference to FIGS. 2 and 3.

The TV includes, among other things, a storage unit 2 adapted to store EPG information among broadcasting signals received through a receiving unit 1, a display unit 4 adapted to display EPG information so that a user can use EPG information stored in the storage unit 2, and an input unit 5 adapted to input a selection command of the user with respect to a predetermined channel among available channels displayed on the display unit 4. The TV further includes a controller 3 adapted to control the storage unit to store EPG information after detecting EPG information in received broadcasting signals, and to control the display unit 4 to display the stored EPG information.

When the selection command for selecting a channel is input through the input unit 5 by the user, the controller 3 controls the display unit 4 to display EPG information of the selected channel and a list of available channels.

As can be appreciated by one skilled in the art, a broadcasting signal is received at the receiving unit 1. The received broadcasting signal not only includes a broadcasting program signal, but also includes a program rating signal for restricting some viewers from watching harmful programs. The received broadcasting signal also includes EPG information in the form of a channel program information signal. The channel information signal included in EPG information includes the genre, the title, and the time of the program, along with any other desirable information that describes the program. The controller 3 stores an EPG signal among various broadcasting signals received from the receiving unit I to the storage unit 2. Then, the controller 3 controls the display unit 4 to display the EPG signal stored in the storage unit 2 on a screen when the user inputs the selection command through the input unit 5 to use EPG information. The user can thus view the broadcasting channel and program information of the channel such as the genre, the title, and the time through EPG information displayed on the display unit 4. The user therefore can select a desired broadcasting program based on EPG information displayed on the display unit 4 through the input unit 5. The input unit 5 can be a manipulation panel (not shown) installed in the TV or a remote controller having a plurality of manipulation buttons.

An example of the EPG information displayed on the screen of the TV will be described in greater detail with regard to FIG. 3. The user enters a command via the input unit 5 by, for example, manipulating EPG manipulation key (not shown) of the remote controller 5 to cause the controller 3 to control the display unit 4 to display a first screen including EPG information. In this example, the channel list is displayed in one vertical column of the screen 4 to allow the user to select the channel information, and the program information such as the time, the title, and the genre of the currently selected channel is displayed on the screen.

In other words, when the user selects a desired channel along the vertical column of the channel list through a predetermined selection key (not shown) such as an up/down key of the input unit 5 (e.g., the remote controller), the program information of the selected channel such as the time, the title, and the genre of the program is displayed on the screen 4. A plurality of channels (CH 3 to CH 10) and the program information corresponding to the channels is displayed in order being overlapped like a telephone number book having indexed names. Therefore, when a channel (CH 10) is selected by the user, the program information of the selected channel (CH 10) is displayed on the screen 4 as shown in FIG. 3.

Furthermore, when the user wants to search other channels besides the channels (CH 3 to CH 10) displayed on the screen 4, the user manipulates the up/down scroll bars A and B through, for example, the selection key (not shown) of the remote controller 5. In other words, to search an upper channel (CH 2), the user manipulates the up scroll bar A disposed at an upper part of the channel list of the vertical column. Then, the channel (CH 2) becomes displayed in the vertical column on the current screen, and the program information of the channel 2 is activated so that the user can retrieve that information, if desired. In this event, the highest currently displayed channel (CH 10) may no longer be displayed on the current display screen due to the scrolling effect, so that CH 9 becomes the highest displayed channel in the vertical column. Similarly, when the user manipulates the down scroll bar B disposed at a lower part of the channel list to search a lower channel (CH I 1), the channel CH 11 appears at the bottom of the vertical column displayed on the screen, in which event the lowest channel (CH 3) is no longer displayed in the column. Then, the program information of the channel CH 11 is activated so that the user can retrieve the information. Each channel can be searched by the up/down scroll bars A and B, or the channel information can be searched for each screen by using the up/down scroll bars A and B. In this example, the selection key can be used as a volume adjustment key and a channel selection key of the remote controller. Therefore, when there are many channels such as the digital broadcasting, the user can easily search the channel information and the program information of the channels.

When the user searches the program information of the selected channel (for example, CH 10), the programming information for a desired time among the program information activated on the screen 4 might not be displayed. In this case, the user searches for the programming at the desired time by manipulating the up/down scroll bars A and B of the vertical column in which the program times are displayed. In other words, to search a program before 8 AM, which is not one of the times currently displayed on the screen 4, the user manipulates an up scroll bar C by using, for example, the selection key (not shown) of the remote controller 5. To search a program after 11 PM, the user manipulates a down scroll bar D by using the selection key (not shown). Therefore, the user can search the program being aired at a desired time for each screen by using the up/down scroll bars C and D in a manner similar to the channel information search. Furthermore, the user can search each screen by using the up/down scroll bar of one screen. The selection key can be, for example, the volume adjustment key or the channel selection key of the remote controller.

Because the program information regarding the plurality of the channels are indexed for each channel and displayed in an overlapped fashion, the plurality of channels can be displayed on one screen. Moreover, as the program information of the currently selected channel is displayed on one screen, complicated manipulation required to access the EPG information can be avoided.

As can further be appreciated from the description of the embodiment of the present invention set forth above, because the channel information of the plurality of channels and the program information of the currently selected channel are displayed on one screen, the user can easily manipulate the input unit 5 to view the EPG information. In addition, as the channel information and the time information of the activated channel are manipulated by the up/down scroll bars, the user can easily search many channels and various time information.

Although the preferred embodiment of the present invention has been described, it will be understood by those skilled in the art that the present invention should not be limited to the described preferred embodiment, but various changes and modifications can be made within the spirit and the scope of the present invention. Accordingly, the scope of the present invention is not limited within the described range but the following claims.

What is claimed is:

1. A television receiver comprising:
a storage unit, adapted to store received electronic programming guide (EPG) information;
a display unit, adapted to display the EPG information;
an input unit, adapted to input a selection command to select a channel among receivable channels; and
a controller, adapted to control the storage unit to store the EPG information among received broadcasting signals, and to control the display unit to display the stored EPG information with respect to the selected channel and a list of channels that can be selected by a user on the display unit on a single screen.

2. The television receiver of claim 1, wherein the EPG information includes at least one of the following:
time information representing times at which the channels air programs;
title information relating to each of the programs; and
genre information pertaining to each of the channels.

3. The television receiver of claim 1, wherein the list displayed on the screen includes:
at least some of the channels that can be selected; and
a display command that enables the user to signal the controller to control the display unit to display other channels that are not currently being displayed on the screen.

4. The television receiver of claim 2, wherein:
the time information among the EPG information is displayed on one part of the screen, and
the display unit is further adapted to display a display command that enables the user to input to the controller via the input unit a command which causes the controller to control the display unit to display time information representing times at which the selected channel airs programs which are not currently being displayed on the screen.

5. The television receiver of claim 1, wherein:
the display unit is adapted to display the list of channels in columnar format.

6. The television receiver of claim 5, wherein:
the display unit is adapted to display the stored EPG information with respect to the selected channel proximate to the displayed list of channels.

7. The television receiver of claim 6, wherein:
the display unit is adapted to display the stored EPG information including a list of programs being aired by the selected channel, the respective times at which the programs are aired, and descriptive information pertaining to each of the programs.

8. A method for controlling a television receiver to display electronic programming guide (EPG) information, comprising:
storing received EPG information;
enabling a user to select a channel among receivable channels; and
controlling a display unit to display the stored EPG information with respect to the selected channel and a list of channels that can be selected by a user on the display unit on a single screen.

9. The method of claim 8, wherein the EPG information includes at least one of the following:
time information representing times at which the channels air programs;
title information relating to each of the programs; and
genre information pertaining to each of the channels.

10. The method of claim 8, wherein the list displayed on the screen includes:
at least some of the channels that can be selected; and
a display command that enables the user to control the display unit to display other channels that are not currently being displayed on the screen.

11. The method of claim 9, wherein:
the time information among the EPG information is displayed on one part of the screen, and
the method further includes controlling the display unit to display a display command that enables the user to control the display unit to display time information representing times at which the selected channel airs programs which are not currently being displayed on the screen.

12. The method of claim 8, wherein:
the controlling step controls the display unit to display the list of channels in columnar format.

13. The method of claim 12, wherein:
the controlling step controls the display unit to display the stored EPG information with respect to the selected channel proximate to the displayed list of channels.

14. The method of claim 13, wherein:
the controlling step controls the display unit to display the stored EPG information including a list of programs being aired by the selected channel, the respective times at which the programs are aired, and descriptive information pertaining to each of the programs.

15. A computer-readable medium of instructions for controlling a television receiver to display electronic programming guide (EPG) information, comprising:
a first set of instructions, adapted to control the television receiver to store received EPG information;
a second set of instructions, adapted to control the television receiver to enable a user to select a channel among receivable channels; and
a third set of instructions, adapted to control a display unit to display the stored EPG information with respect to the selected channel and a list of channels that can be selected by a user on the display unit on a single screen.

16. The computer-readable medium of instructions of claim 15, wherein the EPG information includes at least one of the following:
time information representing times at which the channels air programs;
title information relating to each of the programs; and
genre information pertaining to each of the channels.

17. The computer-readable medium of instructions of claim 15, wherein the list displayed on the screen includes:
at least some of the channels that can be selected; and
a display command that enables the user to control the display unit to display other channels that are not currently being displayed on the screen.

18. The computer-readable medium of instructions of claim 16, wherein:
the time information among the EPG information is displayed on one part of the screen, and
the third set of instructions is further adapted to control the display unit to display a display command that enables the user to control the display unit to display time information representing times at which the selected channel airs programs which are not currently being displayed on the screen.

19. The computer-readable medium of instructions of claim 15, wherein:
the third set of instructions is further adapted to control the display unit to display the list of channels in columnar format.

20. The computer-readable medium of instructions of claim 19, wherein:
the third set of instructions is adapted to control the display unit to display the stored EPG information with respect to the selected channel proximate to the displayed list of channels.

21. The computer-readable medium of instructions of claim 20, wherein:
the third set of instructions is adapted to control the display unit to display the stored EPG information including a list of programs being aired by the selected channel, the respective times at which the programs are aired, and descriptive information pertaining to each of the programs.
